(19) United States
(12) Patent Application Publication
(10) Pub. No.: US 2025/0116982 A1
(43) Pub. Date: Apr. 10, 2025

(54) APPARATUS AND METHOD FOR PROVIDING DIGITAL TWIN USING DATA-BASED REDUCED-ORDER MODEL

(71) Applicant: DOOSAN ENERBILITY CO., LTD., Changwon (KR)

(72) Inventors: Seung Min LEE, Changwon (KR); Luke Park, Yongin (KR); Beom Cheol Hwang, Yongin (KR)

(21) Appl. No.: 18/797,583

(22) Filed: Aug. 8, 2024

(30) Foreign Application Priority Data
Oct. 6, 2023 (KR) 10-2023-0133640

(51) Int. Cl. G05B 17/02

(52) U.S. Cl. CPC G05B 17/02

(57) ABSTRACT

Proposed is an apparatus and a method for providing a digital twin using a data-based reduced-order model. The method for providing a digital twin includes receiving an operation condition for a gas turbine apparatus when the gas turbine apparatus starts to operate, deriving a physical quantity of the gas turbine apparatus's component corresponding to the operation condition by using a reduced-order model including a plurality of sub-models, visualizing the physical quantity of the gas turbine apparatus's component, and controlling the gas turbine apparatus based on the physical quantity.

### CROSS REFERENCE TO RELATED APPLICATION

The present application claims priority to Korean Patent Application No. 10-2023-0133640, filed on Oct. 6, 2023, the entire contents of which are incorporated herein for all purposes by this reference.

### BACKGROUND

### Technical Field

The present disclosure relates to a technology for providing a digital twin and, more particularly, to an apparatus and a method for providing a digital twin using a data-based reduced-order model.

### Description of the Related Art

Recently, the term digital twin has been used in daily life and various industrial fields such as ports, transportation, buildings, energy, and shipbuilding. As a digital twin is used in the process of building and operating a smart city, it is also exposed to citizens in their daily lives and appears on subway and highway billboards to reach people. The superficial form of a digital twin may be to make a virtual twin object in the virtual world for a physical object in the real world, and to make the behavior and actions of the physical object a role model for the performance of the virtual twin object, so that the real world can be simulated and mirrored in the virtual world. Digital twins have been used in part in the manufacturing field since the concept was first introduced in 2002, and have recently gained attention in several industries.

The digital twin is a technology that implements a continuous cyclical adaptation and optimization by exactly simulating real-world objects, systems, and environments within a virtual space in a software system, This allows dynamic motion characteristics and resulting changes of real objects and systems to be simulated in the software system. The optimal state, based on the simulation results, can then be applied to the real system, and changes in the real system to be transmitted back to the virtual system.

### SUMMARY

An objective of the present disclosure is to provide an apparatus and a method providing a digital twin using a data-based reduced-order model.

A method for providing a digital twin according to a preferred exemplary embodiment of the present disclosure for achieving the objective described above includes receiving an operation condition for a gas turbine apparatus when the gas turbine apparatus starts to operate by a measurement unit, deriving a physical quantity of the gas turbine apparatus's component corresponding to the operation condition by using a reduced-order model composed of a plurality of sub-models by an analysis unit, visualizing the physical quantity of the gas turbine apparatus's component by a visualization unit, and controlling, by the analysis unit, the gas turbine apparatus based on the physical quantity.

The deriving of the physical quantity of the component may include aligning the plurality of the sub-models corresponding to a plurality of sections separated on the basis of a rate of change in an output of the gas turbine apparatus according to an operation scenario, the plurality of the sub-models having a sequence, outputting the physical quantity of the component using a first sub-model in the sequence among the plurality of the sub-models after analyzing the operation condition, and outputting the physical quantity of the component using each of the remaining sub-models except for the first sub-model among the plurality of the sub-models after analyzing an output of preceding sub-model of each of the remaining sub-models and the operation condition.

The deriving of the physical quantity of the component may include aligning the plurality of the sub-models, which corresponds to a plurality of operation modes, according to a sequence of an operation scenario, outputting the physical quantity of the component using a first sub-model in the sequence among the plurality of the sub-models after analyzing the operation condition, and outputting the physical quantity of the component using each of remaining sub-models except for the first sub-model among the plurality of the sub-models after analyzing an output of a preceding sub-model of each of the remaining sub-models and the operation condition.

The method may further include generating, by a model generation unit, the reduced-order model, which includes the plurality of the sub-models and derives the physical quantity of the component of the gas turbine apparatus according to the operation condition before the receiving of the operation condition.

The generating of the reduced-order model may include deriving the physical quantity of the component of the gas turbine apparatus according to the operation condition through numerical analysis by the model generation unit, constructing analysis data by mapping the operation condition and the physical quantity of the component derived according to the operation condition by the model generation unit, and generating the reduced-order model that derives the physical quantity of the component of the gas turbine apparatus according to the operation condition using the analysis data by the model generation unit.

The deriving of the physical quantity of the component of the gas turbine apparatus may be characterized in that the model generation unit derives a temperature and a pressure of the component of the gas turbine apparatus according to the operation condition through fluid analysis for the gas turbine apparatus, and the model generation unit derives a stress, a strain, and a displacement of the component of the gas turbine apparatus according to the operation condition through structural analysis for the gas turbine apparatus.

The generating the reduced-order model may include generating the plurality of sub-models corresponding to a plurality of operation modes having a sequence according to an operation scenario by using the analysis data by the model generation unit, and generating the reduced-order model by combining the plurality of sub-models.

The plurality of operation modes may be characterized by having a sequence of a shut-down mode, a cool-down mode, a start-up mode, and an operation mode.

The generating of the reduced-order model may include generating the plurality of sub-models corresponding to a plurality of sections after separating an output of the gas turbine apparatus into the plurality of sections on the basis of a rate of change in the output of the gas turbine apparatus by the model generation unit using the analysis data, and generating the reduced-order model by combining the plurality of sub-models.

The operation condition may include a flow rate and a temperature of a turbine inlet, a flow rate and a temperature of a secondary flow path, and an RPM (revolutions per minute) of a blade.

An apparatus for providing a digital twin according to a preferred exemplary embodiment of the present disclosure for achieving the objective described above includes a measurement unit that receives an operation condition for a gas turbine apparatus when the gas turbine apparatus starts to operate, an analysis unit that derives a physical quantity of a component of the gas turbine apparatus corresponding to the operation condition using a reduced-order model comprising a plurality of sub-models and that controls the gas turbine apparatus based on the physical quantity, and a visualization unit that visualizes the physical quantity of the gas turbine apparatus's component.

The analysis unit may be characterized in aligning the plurality of the sub-models corresponding to a plurality of sections separated on the basis of a rate of change in an output of the gas turbine apparatus according to an operation scenario, the plurality of the sub-models having a sequence, outputting the physical quantity of the component using a first sub-model in the sequence among the plurality of the sub-models after analyzing the operation condition, and outputting the physical quantity of the component using each of remaining sub-models except for the first sub-model among the plurality of the sub-models after analyzing an output of a preceding sub-model of each of the remaining sub-models and the operation condition.

The analysis unit may be characterized in aligning the plurality of the sub-models corresponding to a plurality of operation modes according to a sequence of an operation scenario, the plurality of the sub-models having a sequence, outputting the physical quantity of the component using a first sub-model in the sequence among the plurality of the sub-models after analyzing the operation condition, and outputting the physical quantity of the component using each of remaining sub-models except for the first sub-model among the plurality of the sub-models after analyzing an output of a preceding sub-model of each of the remaining sub-models and the operation condition.

The apparatus may further include a model generation unit configured to generate the reduced-order model that includes the plurality of sub-models and that derives the physical quantity of the component of the gas turbine apparatus according to the operation condition.

The model generation unit may be characterized in deriving the physical quantity of the component of the gas turbine apparatus according to the operation condition through numerical analysis, constructing analysis data by mapping the operation condition and the physical quantity of the component derived according to the operation condition, and generating the reduced-order model that derives the physical quantity of the component of the gas turbine apparatus according to the operation condition using the analysis data.

The model generation unit may be characterized in deriving a temperature and a pressure of the component of the gas turbine apparatus according to the operation condition through fluid analysis for the gas turbine apparatus, and deriving a stress, a strain, and a displacement of the component of the gas turbine apparatus according to the operation condition through structural analysis for the gas turbine apparatus.

The model generation unit may be characterized in generating the plurality of sub-models corresponding to a plurality of operation modes having a sequence according to an operation scenario by using the analysis data, and generating the reduced-order model by combining the plurality of sub-models.

The plurality of operation modes may be characterized by having a sequence of a shut-down mode, a cool-down mode, a start-up mode, and an operation mode.

The generating the reduced-order model may include generating the plurality of the sub-models corresponding to a plurality of sections after separating dividing an output of the gas turbine apparatus into the plurality of sections on the basis of a rate of change in the output of the gas turbine apparatus using the analysis data by the model generation unit and generating the reduced-order model by combining the plurality of sub-models.

The operation condition may include a flow rate and a temperature of a turbine inlet, a flow rate and a temperature of a secondary flow path, and an RPM (revolutions per minute) of a blade.

The present disclosure may more accurately simulate the gas turbine apparatus and derive physical quantities of components by constructing a plurality of sub-models according to a changing trend of analysis data while generating a reduced-order model using analysis data derived through numerical analysis. Accordingly, it is possible to implement a digital twin more precisely using the reduced-order model including the plurality of the sub-models.

### BRIEF DESCRIPTION OF THE DRAWINGS

FIG. 1 is a view for explaining a configuration of a system for providing a digital twin using a data-based reduced-order model.

FIG. 2 is a partially sectioned perspective view of a gas turbine apparatus according to an exemplary embodiment of the present disclosure.

FIG. 3 is a cross-sectional view showing a schematic structure of a gas turbine apparatus according to an exemplary embodiment of the present disclosure.

FIG. 4 is a view for explaining a configuration of an apparatus for providing a digital twin using a data-based reduced-order model according to an exemplary embodiment of the present disclosure.

FIG. 5 is a flowchart for explaining a method for generating a reduced-order model for providing a digital twin according to an exemplary embodiment of the present disclosure.

FIGS. 6 and 7 are views for explaining a method for generating a sub-model for providing a digital twin according to an exemplary embodiment of the present disclosure.

FIG. 8 is a flowchart for explaining a method for providing a digital twin by using a data-based reduced-order model according to an exemplary embodiment of the present disclosure.

FIG. 9 is a view showing a computing device according to an exemplary embodiment of the present disclosure.

### DETAILED DESCRIPTION OF THE DISCLOSURE

Since the present disclosure may be modified in various ways and may have various exemplary embodiments, specific exemplary embodiments will be exemplified and explained in detail in the following description. However, this is not intended to limit the present disclosure to specific exemplary embodiments, and the exemplary embodiments can be construed as including all modifications, equivalents, or substitutes in the spirit and technical scope of the present disclosure.

The terms used in the present disclosure are used only to describe a specific exemplary embodiment and are not intended to limit the present disclosure. Singular expressions include plural expressions unless the context clearly indicates otherwise. In the present disclosure, terms such as “include” or “have” are intended to specify that there exists a feature, number, step, operation, component, part, or combination thereof described in the specification, and should be understood as not precluding the existence or additional possibility of one or more other features or numbers, steps, operations, components, parts, or combinations thereof.

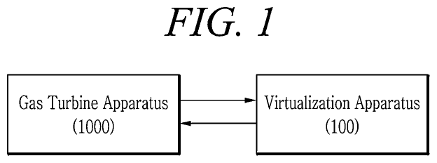

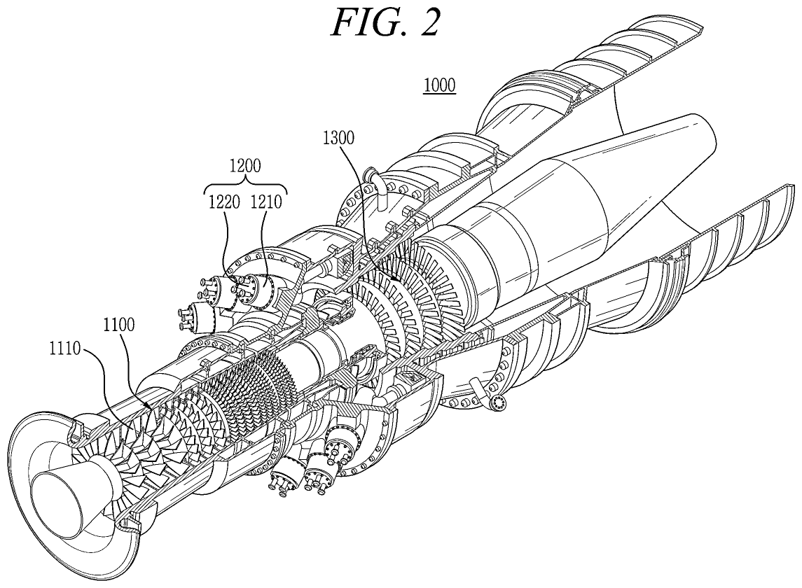

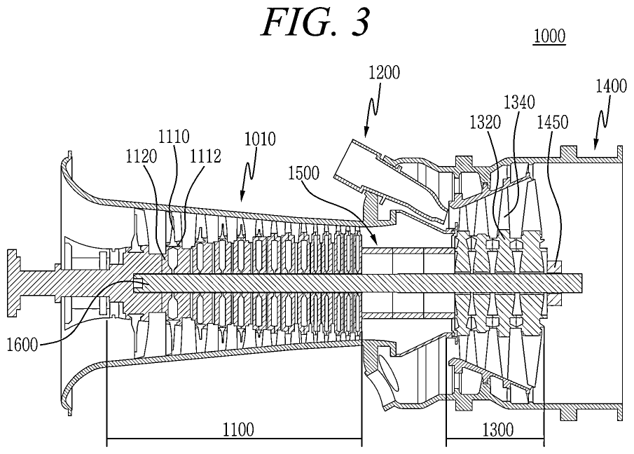

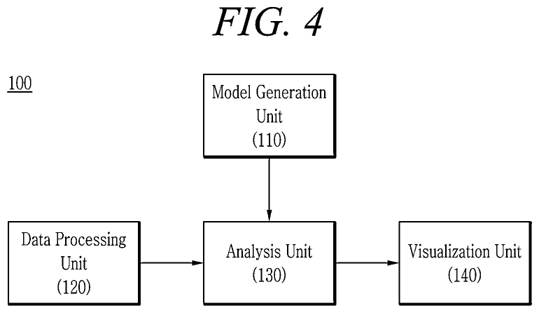

First, a system for providing a digital twin using a data-based reduced-order model according to an exemplary embodiment of the present disclosure will be described. FIG. 1 is a view for explaining a configuration of a system for providing a digital twin using a data-based reduced-order model. FIG. 2 is a partially sectioned perspective view of a gas turbine apparatus according to an exemplary embodiment of the present disclosure, and FIG. 3 is a cross-sectional view showing a schematic structure of a gas turbine apparatus according to an exemplary embodiment of the present disclosure. FIG. 4 is a view for explaining a configuration of an apparatus for providing a digital twin using a data-based reduced-order model according to an exemplary embodiment of the present disclosure.

Referring to FIGS. 1-3, a system for providing a digital twin according to an exemplary embodiment of the present disclosure may include a gas turbine apparatus 1000 and a virtualization apparatus 100. When the gas turbine device 1000 operates, the virtualization apparatus 100 may derive physical quantities of components of the gas turbine apparatus 1000 through a reduced-order model (ROM). The components of the gas turbine apparatus 1000 may include, as representative examples, a blade 1110 of a compressor 1100 or a blade 1340 of a turbine 1300. Also, the virtualization apparatus 100 may provide visualized physical quantities of derived components.

Referring to FIGS. 2 and 3, the gas turbine apparatus 1000 may include a compressor 1100, a combustor 1200, and a turbine 1300. The compressor 1100 may be provided with a plurality of blades 1110 installed radially. The compressor 1100 may rotate the blade 1110 so that the air is compressed and moved by the rotation of the blades 1110. The size and installation angle of the blade 1110 may vary depending on the installation location. In an exemplary embodiment, the compressor 1100 may be directly or indirectly connected to the turbine 1300, and receive a portion of the power generated by the turbine 1300 and utilize the same for rotating the blade 1110.

The air compressed in the compressor 1100 may move to the combustor 1200. The combustor 1200 may include a plurality of combustion chambers 1210 arranged in an annular shape and a fuel nozzle module 1220.

As shown in the drawing, the gas turbine apparatus 1000 according to an exemplary embodiment of the present disclosure may be provided with a housing 1010, wherein a diffuser 1400 through which combustion gas passing through the turbine is discharged is provided at the rear side of the housing 1010. In addition, a combustor 1200 for receiving and combusting compressed air may be disposed in front of the diffuser 1400.

Explaining on the basis of the direction of air flow, the compressor 1100 may be located on the upstream side of the housing 1010, and the turbine 1300 may be disposed on the downstream side. In addition, a torque tube unit 1500 may be disposed between the compressor 1100 and the turbine 1300 as a torque transmission member that transmits a rotation torque generated in the turbine 1300 to the compressor 1100.

The compressor section 1100 may be provided with a plurality of compressor rotor disks 1120, and each compressor rotor disk 1120 may be fastened by a tie rod 1600 so as not to be spaced apart in the shaft direction.

Specifically, each compressor rotor disk 1120 may be aligned with each other along the shaft direction in a state where the tie rod 1600 composing the rotation shaft passes through approximately the center. Herein, each neighboring compressor rotor disk 1120 may be disposed such that the opposite surface thereof is compressed against the tie rod 1600 so that relative rotation is impossible.

A plurality of blades 1110 may be radially coupled to the outer peripheral surface of the compressor rotor disk 1120. Each blade 1110 may be provided with a dovetail portion 1112 and may be fastened to the compressor rotor disk 1120.

A vane (not shown) fixed to and disposed in the housing 1010 may be located between each rotor disk 1120. Unlike the rotor disk, the vane may be fixed not to rotate, and may serve to align the flow of compressed air passing through the blades of the compressor rotor disk and to guide the air to the blades of the rotor disk located on the downstream side.

A fastening method of the dovetail portion 1112 may include a tangential type and an axial type. The method may be selected according to the required structure of a commercially available gas turbine, and may have a commonly known dovetail or fir-tree shape. In some cases, the blade may be fastened to the rotor disk using a fastening device other than the shape above, for example, a fixing tool such as a key or a bolt.

The tie rod 1600 may be disposed to penetrate the center of a plurality of compressor rotor disks 1120 and turbine rotor disks 1320, and the tie rod 1600 may be composed of one or a plurality of tie rods. One side end of the tie rod 1600 may be fastened within the compressor rotor disk located on the most upstream side, and the other side end of the tie rod 1600 may be fastened by a fixing nut 1450. The shape of the tie rod 1600 may have various structures depending on the gas turbine, so it may be not necessarily limited to the shape shown in FIG. 2. That is, as shown in the drawing, a single tie rod may have a shape penetrating the center of the rotor disk, or a plurality of tie rods may have a shape of being disposed circumferentially, and a combination thereof may be possible.

Although not shown, in the compressor of the gas turbine, a vane that serves as a guide vane may be installed at the next location of the diffuser in order to adjust the flowing angle of the fluid flow entering the inlet of the combustor to the design flowing angle after increasing the pressure of the fluid flow, which is called a deswirler.

In the combustor 1200, the incoming compressed air may be mixed with fuel and combusted to generate a high energy, high temperature, high pressure combustion gas, and through the isobaric combustion process, the temperature of the combustion gas may reach the heat resistance limit that the combustor and turbine components can withstand.

The combustors composing the combustion system of the gas turbine may be arranged in a plurality in a housing formed in a cell shape, and may be composed of a burner including a fuel injection nozzle, a combustor liner forming a combustion chamber, and a transition piece that becomes a connection between the combustor and the turbine.

Specifically, the liner may provide a combustion space where fuel injected by the fuel nozzle is mixed and combusted with the compressed air of the compressor. Such a liner may include a flame tube that provides a combustion space where the fuel mixed with air is combusted, and a flow sleeve that forms the annular space while surrounding the flame tube. In addition, a fuel nozzle may be coupled to the front end of the liner, and an ignition plug may be coupled to the side wall.

Meanwhile, a transition piece may be connected to the rear end of the liner so that the combustion gas combusted by the ignition plug can be sent toward the turbine. The outer wall of this transition piece may be cooled by compressed air supplied from the compressor in order to prevent damage due to the high temperature of combustion gas.

For this purpose, the transition piece may be provided with holes for cooling so that air can be sprayed into the inside, and the compressed air may cool the main body inside through the holes and then may flow toward the liner.

The cooling air that cools the transition piece described above may flow in the annular space of the liner, and compressed air outside of the flow sleeve may be provided as cooling air through cooling holes provided in the flow sleeve and may collide in the outer wall of the liner.

Meanwhile, the high-temperature and high-pressure combustion gas from the combustor may be supplied to the turbine 1300. The supplied high-temperature and high-pressure combustion gas may cause the rotation torque by giving a reaction force while expanding and colliding with the rotating blade of the turbine, and the rotation torque obtained in such a way may be transmitted to the compressor through the torque tube described above, and the power in excess of the power required for driving the compressor may be used to drive the generator.

The turbine 1300 may be basically similar to the structure of the compressor. That is, the turbine 1300 may be also provided with a plurality of turbine rotor disks 1320 similar to the compressor rotor disk of the compressor. Accordingly, the turbine rotor disk 1320 may also include a plurality of turbine blades 1340 arranged radially.

The turbine blade 1340 may also be coupled to the turbine rotor disk 1320 in a dovetail or other manner. Further, a turbine vane (not shown) fixed to the housing 1010 may be provided between the blades 1340 of the turbine rotor disk 1320 and guide the flow direction of the combustion gas passing through the blade 1340.

As shown in FIG. 3, the turbine rotor disk 1320 may have a roughly disk-like shape, and a plurality of coupling slots may be formed at an outer peripheral surface thereof. The coupling slot may be formed to have a curved surface of a firs-tree shape.

The turbine blade 1340 may be fastened to the coupling slot. In FIG. 3, the turbine blade 1340 may have a platform portion of a flat shape around the center. The platform portion may serve to maintain a gap between the blades by contacting the platform portion of a neighboring turbine blade and the side surface thereof to each other.

A root portion may be formed on the lower surface of the platform portion. The root portion may have an axial-type shape that is inserted along the shaft direction of the rotor disk 1320 into the coupling slot of the rotor disk 1320 described above.

The root portion may have a curved portion of roughly a fir-tree shape, which is formed to correspond to the shape of the curved portion formed in the coupling slot. Herein, the coupling structure of the root portion may not necessarily have a fir-tree shape, but may be formed to have a dovetail shape.

A blade portion may be formed on the upper surface of the platform portion. The blade portion may be formed to have an airfoil optimized according to the specifications of the gas turbine, and may have a leading edge disposed on the upstream side and a trailing edge disposed on the downstream side on the basis of the flow direction of the combustion gas.

Herein, unlike the blade of the compressor, the blade of the turbine may come into direct contact with the combustion gas of high temperature and high pressure. The temperature of the combustion gas may be high enough to reach 1700° C., so a cooling means may be required. To this end, there may be a cooling passage that extracts compressed air from some parts of the compressor and supplies the same to the blades of the turbine.

The cooling passage may extend from the outside of the housing (an external passage), may extend through the inside of the rotor disk (an internal passage), or may use both external and internal passages. A plurality of film cooling holes may be formed on a surface of the blade portion, and the film cooling holes may serve to supply cooling air to the surface of the blade portion while communicating with a cooling channel formed inside the blade portion.

Meanwhile, the blade portion of the turbine may be rotated by the combustion gas inside the housing, and a gap may exist between the end side of the blade portion and the inner surface of the housing so that the blade portion may rotate smoothly. However, as described above, the combustion gas may leak through the gap, so a sealing means may be required to block the same.

Both the turbine vane and the turbine blade may be in the form of airfoil and be composed of a leading edge, a trailing edge, a suction surface, and a pressure surface. The inside of the turbine vane and the turbine blade may include a complex labyrinth structure that forms the cooling system. The cooling circuit within the vane and the blade may accommodate cooling fluid, for example, air, from the compressor of the turbine engine and the fluid may pass through the end side of the vane and the blade that is coupled to the vane and blade carriers. The cooling circuit may usually include a plurality of flow passages designed to maintain all sides of the turbine vane and blade at a relatively uniform temperature, and at least some of the fluid passing through the cooling circuit may be discharged through openings of the leading edge, the trailing edge, the suction surface, and the pressure surface of the vane. A plurality of cooling channels composing the cooling circuit may be provided inside the vane and the blade, and a metering plate may be provided at the inlet side of the plurality of cooling channels. A cooling hole corresponding to the inlet of each cooling channel may be formed in the metering plate one by one. However, as the cooling fluid passes through the cooling hole of the metering plate, a strong jet may be formed, and in particular, a flow stagnation area may occur in the lower front portion of the leading edge.

Referring to FIG. 4, the virtualization apparatus 100 may be for providing a digital twin for components of the gas turbine apparatus 1000 described with reference to FIGS. 2 and 3, for example, the blade 1110 of the compressor 1100 or the blade 1340 of the turbine 1300. The virtualization apparatus 100 may include a model generation unit 110, a measurement unit 120, an analysis unit 130, and a visualization unit 140. Meanwhile, the blade 1110 of the compressor 1100 will be mainly described as an example in the following exemplary embodiments, but those skilled in the art will appreciate that the blade 1340 of the turbine 1300 or any other components of the turbine apparatus 1000 may also be managed in the same or a similar manner.

The model generation unit 110 may be for generating a reduced-order model to provide a digital twin. To this end, the model generation unit 110 may derive physical quantities of components of the gas turbine apparatus 1000 according to operation conditions through numerical analysis, and may construct analysis data by mapping operation conditions and physical quantities of the components derived according to the operation conditions. The numerical analysis may include computational fluid dynamics (CFD), finite element analysis (FEA), finite element method (FEM), and the like. Herein, the physical quantity of the component may include temperature, pressure, stress, strain, and displacement. In addition, the operation conditions may include a flow rate and temperature at an inlet of the turbine 1300 of the gas turbine apparatus 1000, a flow rate and temperature of a secondary flow path of the gas turbine apparatus 1000, and a revolutions per minute (RPM) of the blades 1110, 1340. According to an exemplary embodiment, the model generation unit 110 may derive the temperature and pressure of the component of the gas turbine apparatus 1000 according to the operation condition through fluid analysis for the gas turbine apparatus 1000. In addition, the model generation unit 110 may derive stress, strain, and displacement of the component of the gas turbine apparatus 1000 according to the operation condition through structural analysis for the gas turbine apparatus 110. When the analysis data is constructed in this way, the model generation unit 110 may generate the reduced-order model that derives the physical quantities of the components of the gas turbine apparatus 1000 according to the operation conditions using the analysis data. The reduced-order model according to an exemplary embodiment of the present disclosure may include a plurality of sub-models. That is, the model generation unit 110 may generate the reduced-order model that includes the plurality of sub-models using the analysis data. When the reduced-order model is generated, the digital twin may be provided through the generated reduced-order model.

The measurement unit 120 may be for collecting operation conditions for the gas turbine apparatus 1000. When the operation of the gas turbine apparatus 1000 starts, the measurement unit 120 may receive operation conditions for the gas turbine apparatus 1000. The operation conditions may include a flow rate and temperature at the inlet of the turbine 1300 of the gas turbine apparatus 1000, a flow rate and temperature of the secondary flow path of the gas turbine apparatus 1000, and a revolutions per minute (RPM) of the blades 1110, 1340. These operation conditions may be collected through a sensor (not shown) installed in the gas turbine apparatus 1000.

The analysis unit 130 may be for deriving physical quantities of components of the gas turbine apparatus 1000 corresponding to the operation conditions by using the reduced-order model that includes the plurality of sub-models. The analysis unit 130 may input the corresponding operation conditions into the reduced-order model. Then, the reduced-order model may derive physical quantities of components of the gas turbine apparatus 1000 corresponding to the inputted operation conditions through inference on the inputted operation conditions. Meanwhile, the analysis unit 130 may transmit control signal to the gas turbine apparatus 1000. For example, the analysis unit 130 may control the operation of the gas turbine apparatus 1000 including increasing or decreasing the gas turbine's output, stopping the gas turbine operation, or performing other necessary controls related to gas turbine operation based on the output of the reduced order model.

When the physical quantity of the component of the gas turbine apparatus 1000 is derived, the visualization unit 140 may visualize and output the physical quantity of the component of the gas turbine apparatus 1000. In this case, the visualization unit 140 may visualize and output the temperature, pressure, stress, strain and displacement of the components. This visualization may be performed using colors and shapes.

A specific operation of the virtualization apparatus 100 including the model generation unit 110, the measurement unit 120, the analysis unit 130, and the visualization unit 140 described above will be described in more detail below.

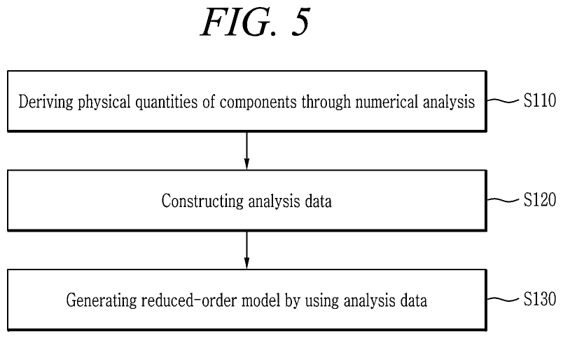

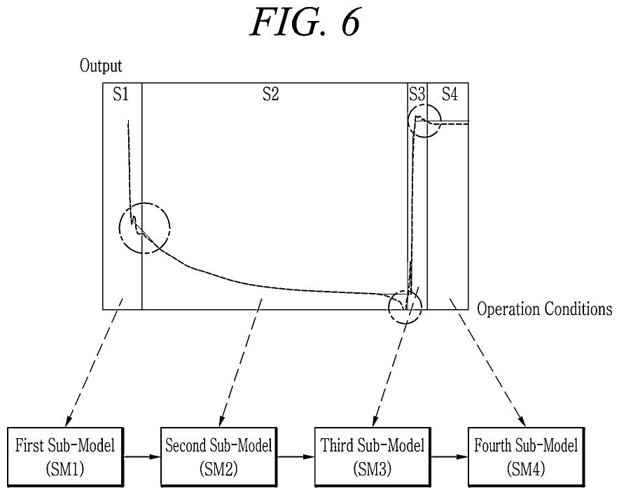

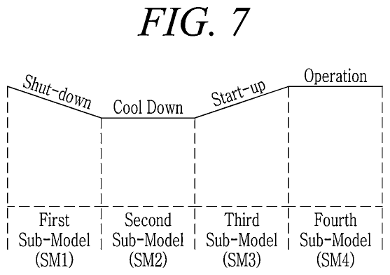

Next, the method for generating the reduced-order model for providing a digital twin according to an exemplary embodiment of the present disclosure will be described. FIG. 5 is a flowchart for explaining the method for generating the reduced-order model for providing a digital twin according to an exemplary embodiment of the present disclosure. FIGS. 6 and 7 are views for explaining the method for generating the sub-model for providing a digital twin according to an exemplary embodiment of the present disclosure.

Referring to FIG. 5, the model generation unit 110 may derive physical quantities of components of the gas turbine apparatus 1000 according to operation conditions through numerical analysis in step S110. Herein, the physical quantities of the components may include temperature, pressure, stress, strain and displacement. Herein, the numerical analysis may be exemplified by computational fluid dynamics (CFD), finite element analysis (FEA), finite element method (FEM), and the like. For example, the component may include blades 1110, 1340. The operation conditions may include a flow rate and temperature at an inlet of a turbine 1300 of the gas turbine apparatus 1000, a flow rate and temperature of a secondary flow path of the gas turbine apparatus 1000, and a revolutions per minute (RPM) of the blades 1110, 1340.

According to an exemplary embodiment, the model generation unit 110 may derive the temperature and pressure of the components of the gas turbine apparatus 1000 according to operation conditions through fluid analysis for the gas turbine apparatus 1000 in step S110. In addition, the model generation unit 110 may derive the stress, strain, and displacement of the components of the gas turbine apparatus 1000 according to operation conditions through structural analysis for the gas turbine apparatus 1000.

Next, the model generation unit 110 may construct analysis data by mapping the operation condition and the physical quantity of the component derived according to the operation condition in step S120.

Subsequently, the model generation unit 110 may generate the reduced-order model that derives physical quantities of components of the gas turbine apparatus according to operation conditions by using the analysis data in step S130. The reduced-order model according to an exemplary embodiment of the present disclosure may include the plurality of sub-models. That is, the model generation unit 110 may generate the reduced-order model that includes the plurality of sub-models by using the analysis data.

According to an exemplary embodiment, during the operation of the gas turbine apparatus 1000, there may be a section where the rate of change in the output of the gas turbine apparatus 1000 rapidly varies according to the operation conditions determined based on an operation scenario, as shown in the analysis data in FIG. 6. It may be possible to separate the output of the gas turbine apparatus 1000 into a plurality of sections (S1, S2, S3, and S4) having a sequence based on the rate of change. That is, a section may be identified when the rate of change in the output is greater than or equal to a predetermined value. Accordingly, the model generation unit 110 may divide the output of the gas turbine apparatus 1000 into the plurality of sections having the sequence based on the rate of change according to the analysis data, and may generate the plurality of sub-models corresponding to the plurality of sections. In the case of FIG. 6, four sub-models (SM1, SM2, SM3, and SM4) may be generated. Each sub-model may be generated in the sequence of the plurality of sections. In addition, each sub-model may be generated using the analysis data corresponding to its respective section and the output of the sub-model from the preceding section in the sequence. Also, the model generation unit 110 may generate the reduced-order model by combining the plurality of sub-models.

Referring to FIG. 7, according to another exemplary embodiment, the gas turbine apparatus 1000 may operate according to a plurality of operation modes having a sequence according to an operation scenario. The plurality of operation modes having the sequence, as shown in FIG. 7, may include a shut-down mode, a cool-down mode, a start-up mode, and an operation mode.

The model generation unit 110 may generate the plurality of sub-models corresponding to the plurality of operation modes having the sequence, the sequence being determined based on the operation scenario, by using the analysis data. Each sub-model may be generated using the analysis data corresponding to each of the plurality of operation modes. For example, as shown in FIG. 7, a first to fourth sub-models (SM1, SM2, SM3, and SM4) may be generated corresponding to each of the shut-down mode, the cool-down mode, the start-up mode, and the operation mode, respectively. Each sub-model may be generated according to the sequence for the plurality of operation modes (SM1, SM2, SM3, and SM4). In addition, each sub-model may be generated using the analysis data corresponding to each operation mode and the output of the sub-model from the preceding operation mode in the sequence. Also, the model generation unit 110 may generate the reduced-order model by combining the plurality of sub-models.

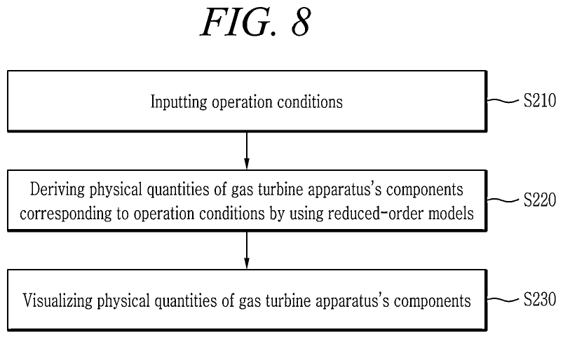

As described above, when the reduced-order model is generated, the digital twin may be provided through the generated reduced-order model. FIG. 8 is a flowchart for explaining a method for providing a digital twin using a data-based reduced-order model according to an exemplary embodiment of the present disclosure.

Referring to FIG. 8, when the operation of the gas turbine apparatus 1000 starts, the measurement unit 120 may receive the operation condition for the gas turbine apparatus 1000 in step S210.

When the operation condition is inputted, the analysis unit 130 may derive physical quantities of components of the gas turbine apparatus corresponding to the operation condition by using the reduced-order model that includes the plurality of sub-models in step S220.

According to an exemplary embodiment in step S220, the analysis unit 130 may align the plurality of sub-models corresponding to the plurality of sections separated on the basis of the rate of change in the output of the gas turbine apparatus according to the operation scenario. The plurality of sections have a sequence that is determined based on the operation scenario and that the plurality of sub-models follow. A first sub-model (e.g., SM1 in FIG. 6) in the sequence of the plurality of sections among the plurality of sub-models may analyze the operation condition of the corresponding section and may output the physical quantities of the components. Also, each of the remaining sub-models except for the first sub-model among the plurality of the sub-models may analyze the output of a preceding sub-model of each of the remaining sub-models and the operation condition of the corresponding section and may output the physical quantities of the components.

According to another exemplary embodiment, in step S220, the analysis unit 130 may align the plurality of sub-models corresponding to the plurality of operation modes according to the operation scenario. The plurality of operation modes have a sequence that is determined based on the operation scenario and that the plurality of sub-models follow. Then, the first sub-model (e.g., SM1 in FIG. 7) among the plurality of sub-models may analyze the operation condition of the corresponding operation mode and may output the physical quantities of the component. Next, each of the remaining sub-models (e.g., SM2, SM3, and SM4 in FIG. 7) except for the first sub-model among the plurality of sub-models may analyze the output of a preceding sub-model of each of the remaining sub-models and the operation condition of the corresponding operation mode, and may output the physical quantities of the component.

When the physical quantities of the components of the gas turbine apparatus 1000 are derived, the visualization unit 140 may visualize and output the physical quantities of the components of the gas turbine apparatus 1000 in step S230. That is, the visualization unit 140 may visualize and output the temperature, pressure, stress, strain, and displacement of the component. This visualization may be performed using colors and shapes. Additionally, in step S230, the analysis unit 130 may transmit control signal to the gas turbine apparatus 1000. For example, the analysis unit 130 may control the operation of the gas turbine apparatus 1000 including increasing or decreasing the gas turbine's output, stopping the gas turbine operation, or performing other necessary controls related to gas turbine operation based on the output of the reduced order model.

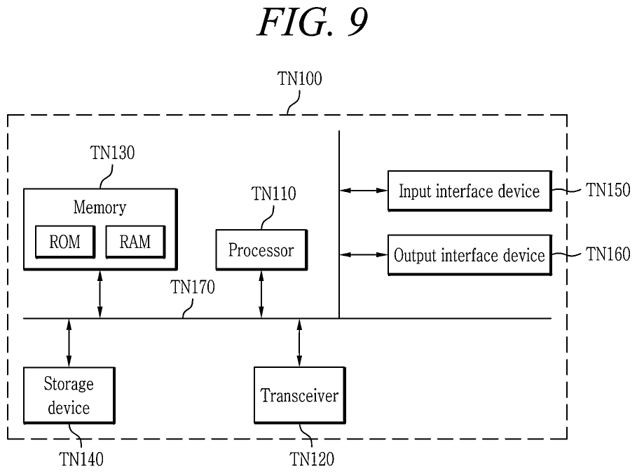

FIG. 9 is a view showing a computing device according to an exemplary embodiment of the present disclosure. A computing device TN100 of FIG. 9 may be the apparatus (e.g., a virtualization apparatus 100 or the like) described in the present specification.

In the exemplary embodiment of FIG. 9, the computing device TN100 may include at least one processor TN110, a transceiver TN120, and a memory TN130. In addition, the computing device TN100 may further include a storage device TN140, an input interface device TN150, an output interface device TN160, and the like. The components included in the computing device TN100 may be connected by a bus TN170 to communicate with each other.

The processor TN110 may execute a program command stored in at least one of the memory TN130 and the storage device TN140. The processor TN110 may refer to a central processing unit (CPU), a graphics processing unit (GPU), or a dedicated processor in which methods according to exemplary embodiments of the present disclosure are performed. The processor TN110 may be configured to implement procedures, functions, and methods described in relation to an exemplary embodiment of the present disclosure. The processor TN110 may control each component of the computing device TN100.

Each of the memory TN130 and the storage device TN140 may store various information in relation to the operation of the processor TN110. Each of the memory TN130 and the storage device TN140 may be composed of at least one of a volatile storage medium and a nonvolatile storage medium. For example, the memory TN130 may be composed of at least one of a read-only memory (ROM) and a random access memory (RAM).

The transceiver TN120 may transmit or receive wired signals or wireless signals. The transceiver TN120 may be connected to a network to perform communication. At least one of the transceiver TN120 and the output interface device TN160 may be used to transmit data including the control signal and visualized physical quantity to an external device including gas turbine apparatus 1000 and a display device.

Meanwhile, the various methods described above according to an exemplary embodiment of the present disclosure may be implemented in the form of a program readable through various computer means and may be recorded on a computer-readable recording medium. Herein, the recording medium may include a program command, a data file, a data structure, and the like, alone or in combination thereof. The program commands recorded on the recording medium may be designed and configured specifically for the present disclosure or may be known and usable by those skilled in the art in computer software. For example, the recording medium may include a magnetic medium such as a hard disk, a floppy disk, and a magnetic tape, an optical medium such as a CD-RCM, and a DVD, a magnetic-optical medium such as a floptical disk, and a hardware device, such as ROM, RAM, and a flash memory, which is specifically configured to store and execute program commands. Examples of program commands may include not only machine language, such as those created by a compiler, but also an advanced language that may be executed by a computer using an interpreter. Such hardware devices may be configured to operate as one or more software modules in order to perform the operations of the present disclosure, and vice versa.

Although exemplary embodiments of the present disclosure have been described above, those skilled in the art can add, change, delete or append components without departing from the spirit of the present disclosure as recited in the following claims, which will be included within the scope of rights of the present disclosure.

What is claimed is:

1. A method for providing a digital twin, the method comprising:
receiving, by a measurement unit, an operation condition for a gas turbine apparatus when the gas turbine apparatus starts to operate;
deriving, by an analysis unit, a physical quantity of a component of the gas turbine apparatus corresponding to the operation condition using a reduced-order model comprising a plurality of sub-models;
visualizing, by a visualization unit, the physical quantity; and
controlling, by the analysis unit, the gas turbine apparatus based on the physical quantity.

2. The method of claim 1, wherein the deriving of the physical quantity of the component comprises:
aligning the plurality of the sub-models, which corresponds to a plurality of sections separated on the basis of a rate of change in an output of the gas turbine apparatus, according to an operation scenario, the plurality of the sub-models having a sequence;
outputting the physical quantity using a first sub-model in the sequence among the plurality of the sub-models after analyzing the operation condition; and
outputting the physical quantity using each of remaining sub-models except for the first sub-model among the plurality of the sub-models after analyzing an output of a preceding sub-model of each of the remaining sub-models and the operation condition.

3. The method of claim 1, wherein the deriving of the physical quantity of the component comprises:
aligning the plurality of the sub-models, which corresponds to a plurality of operation modes, according to an operation scenario, the plurality of the sub-models having a sequence;
outputting the physical quantity using a first sub-model in the sequence among the plurality of the sub-models after analyzing the operation condition; and
outputting the physical quantity using each of remaining sub-models except for the first sub-model among the plurality of the sub-models after analyzing an output of a preceding sub-model of each of the remaining sub-models and the operation condition.

4. The method of claim 1, further comprising:
generating, by a model generation unit, the reduced-order model, which includes the plurality of sub-models and derives the physical quantity of the component of the gas turbine apparatus, according to the operation condition, before the receiving of the operation condition.

5. The method of claim 4, wherein the generating of the reduced-order model comprises:
deriving the physical quantity of the component of the gas turbine apparatus according to the operation condition through numerical analysis;
constructing analysis data by mapping the operation condition and the physical quantity of the component derived according to the operation condition; and
generating the reduced-order model according to the operation condition using the analysis data.

6. The method of claim 5, wherein the deriving of the physical quantity of the component of the gas turbine apparatus is characterized in that
the model generation unit derives a temperature and a pressure of the component of the gas turbine apparatus according to the operation condition through fluid analysis for the gas turbine apparatus, and
the model generation unit derives a stress, a strain, and a displacement of the component of the gas turbine apparatus according to the operation condition through structural analysis for the gas turbine apparatus.

7. The method of claim 5, wherein the generating of the reduced-order model comprises:
generating the plurality of sub-models corresponding to a plurality of operation modes having a sequence according to an operation scenario by using the analysis data; and
generating the reduced-order model by combining the plurality of sub-models.

8. The method of claim 7, wherein the plurality of operation modes are characterized by having a sequence of a shut-down mode, a cool-down mode, a start-up mode, and an operation mode.

9. The method of claim 5, wherein the generating of the reduced-order model comprises:
generating the plurality of sub-models corresponding to a plurality of sections after separating an output of the gas turbine apparatus into the plurality of sections on the basis of a rate of change in the output, using the analysis data; and
generating the reduced-order model by combining the plurality of sub-models.

10. The method of claim 6, wherein the operation condition comprises a flow rate and a temperature of a turbine inlet, a flow rate and a temperature of a secondary flow path, and an revolutions per minute (RPM) of a blade.

11. An apparatus for providing a digital twin, the apparatus comprising:
a measurement unit that receives an operation condition for a gas turbine apparatus when the gas turbine apparatus starts to operate;
an analysis unit that derives a physical quantity of a component of the gas turbine apparatus corresponding to the operation condition using a reduced-order model comprising a plurality of sub-models and that controls the gas turbine apparatus based on the physical quantity; and
a visualization unit that visualizes the physical quantity.

12. The apparatus of claim 11, wherein the analysis unit is configured to:
align the plurality of the sub-models, which corresponds to a plurality of sections separated on the basis of a rate of change in an output of the gas turbine apparatus, according to an operation scenario, the plurality of the sub-models having a sequence,
output the physical quantity using a first sub-model in the sequence among the plurality of the sub-models after analyzing the operation condition, and
output the physical quantity using each of remaining sub-models except for the first sub-model among the plurality of the sub-models after analyzing an output of a preceding sub-model of each of the remaining sub-models and the operation condition.

13. The apparatus of claim 11, wherein the analysis unit is configured to:
align the plurality of the sub-models, which corresponds to a plurality of operation modes, according to an operation scenario, the plurality of the sub-models having a sequence,
output the physical quantity using a first sub-model in the sequence among the plurality of the sub-models after analyzing the operation condition, and
output the physical quantity using each of remaining sub-models except for the first sub-model among the plurality of the sub-models after analyzing an output of a preceding sub-model of each of the remaining sub-models and the operation condition.

14. The apparatus of claim 11, further comprising:
a model generation unit configured to generate the reduced-order model that includes the plurality of sub-models and that derives the physical quantity of the component of the gas turbine apparatus according to the operation condition.

15. The apparatus of claim 14, wherein the model generation unit is configured to:
derive the physical quantity of the component of the gas turbine apparatus according to the operation condition through numerical analysis,
construct analysis data by mapping the operation condition and the physical quantity of the component derived according to the operation condition, and
generate the reduced-order model according to the operation condition using the analysis data.

16. The apparatus of claim 15, wherein the model generation unit is configured to:
derive a temperature and a pressure of the component of the gas turbine apparatus according to the operation condition through fluid analysis for the gas turbine apparatus, and
derive a stress, a strain, and a displacement of the component of the gas turbine apparatus according to the operation condition through structural analysis for the gas turbine apparatus.

17. The apparatus of claim 15, wherein the model generation unit is configured to:
generate the plurality of sub-models corresponding to a plurality of operation modes having a sequence according to an operation scenario by using the analysis data, and
generate the reduced-order model by combining the plurality of sub-models.

18. The apparatus of claim 17, wherein the plurality of operation modes are characterized by having a sequence of a shut-down mode, a cool-down mode, a start-up mode, and an operation mode.

19. The apparatus of claim 15, wherein the model generation unit is configured to:
generate the plurality of sub-models corresponding to a plurality of sections after dividing an output of the gas turbine apparatus into the plurality of sections on the basis of a rate of change in the output, using the analysis data, and
generating the reduced-order model by combining the plurality of sub-models.

20. The apparatus of claim 16, wherein the operation condition comprises a flow rate and a temperature of a turbine inlet, a flow rate and a temperature of a secondary flow path, and an revolutions per minute (RPM) of a blade.
